(19) United States
(12) Patent Application Publication
(10) Pub. No.: US 2023/0031251 A1
(43) Pub. Date: Feb. 2, 2023

(54) VEHICLE LATERAL DYNAMICS ESTIMATION USING TELEMETRY DATA

(71) Applicant: GM GLOBAL TECHNOLOGY OPERATIONS LLC, Detroit, MI (US)

(72) Inventors: Shu Chen, Rochester Hills, MI (US); Donald K. Grimm, Utica, MI (US)

(21) Appl. No.: 17/389,489

(22) Filed: Jul. 30, 2021

(51) Int. Cl. G08G 1/01; G01C 21/34; G08G 1/052

(52) U.S. Cl. CPC G08G 1/0137; G01C 21/3484; G08G 1/052; G08G 1/0112

(57) ABSTRACT

A system includes a processor and a memory storing instructions which when executed by the processor configure the processor to receive telemetry data from a vehicle being driven in a road segment, detect lane changes made by the vehicle in the road segment based on the telemetry data, and characterize the road segment and driver behavior based on the lane changes and the telemetry data.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to estimating lateral dynamics of vehicles using telemetry data.

Based on data analyzed by the national highway traffic safety administration (NHTSA), at least 33% of all vehicle crashes occur when vehicles change lanes or veer off road. Identifying lateral dynamics of vehicles such as lane changes can help reduce crashes and other accidents.

### SUMMARY

A system comprises a processor and a memory storing instructions which when executed by the processor configure the processor to receive telemetry data from a vehicle being driven in a road segment, detect lane changes made by the vehicle in the road segment based on the telemetry data, and characterize the road segment and driver behavior based on the lane changes and the telemetry data.

In other features, the instructions further configure the processor to estimate a location of the vehicle in a lane using the telemetry data and a model, estimate a lateral velocity of the vehicle, and detect the lane changes based on the location and the lateral velocity.

In other features, the instructions further configure the processor to detect a lane change when the vehicle moves from a center of the lane to a boundary of the lane, from the boundary of the lane to a boundary of an adjacent lane, from the boundary of the adjacent lane to a center of the adjacent lane.

In other features, the instructions further configure the processor to determine a time taken by the vehicle to make each of the lane changes, and characterize the road segment and the driver behavior based on the time taken by the vehicle to make each of the lane changes.

In other features, the instructions further configure the processor to characterize the road segment and the driver behavior based on a plurality of lane changes made by the vehicle and by other vehicles in the road segment.

In other features, the instructions further configure the processor to inform drivers of the vehicle and other vehicles about the characterizations of the road segment and the driver behavior for navigation planning.

In other features, the instructions further configure the processor to control the vehicle and other vehicles based on the characterizations of the road segment and the driver behavior.

In other features, the instructions further configure the processor to determine a location of the vehicle in a lane based on the telemetry data and mapping data of the lane received from a lane-level mapping system, and detect the lane changes based on the determined location of the vehicle.

In other features, the instructions further configure the processor to divide a road on which the vehicle is being driven into customized road segments, which include the road segment, receive the telemetry data from the vehicle as the vehicle is being driven on the road, determine location information of the vehicle based on the telemetry data and mapping data of the road received from a road-level mapping system, cache the location information paired with the road segments, detect the lane changes by processing the cached location information paired with the road segments, and characterize the road segments and the driver behavior based on the lane changes and the telemetry data.

In other features, the instructions further configure the processor to provide the characterization of the road segment to a traffic management system, provide the characterization of the driver behavior to a fleet management system associated with the vehicle, and provide the characterization of the driver behavior to an insurer.

In still other features, a method comprises receiving telemetry data from a vehicle being driven in a road segment, detecting lane changes made by the vehicle in the road segment based on the telemetry data, and characterizing the road segment and driver behavior based on the lane changes and the telemetry data.

In other features, the method further comprises estimating a location of the vehicle in a lane using the telemetry data and a model, estimating a lateral velocity of the vehicle, and detecting the lane changes based on the location and the lateral velocity.

In other features, the method further comprises detecting a lane change when the vehicle moves from a center of the lane to a boundary of the lane, from the boundary of the lane to a boundary of an adjacent lane, from the boundary of the adjacent lane to a center of the adjacent lane.

In other features, the method further comprises determining a time taken by the vehicle to make each of the lane changes and characterizing the road segment and the driver behavior based on the time taken by the vehicle to make each of the lane changes.

In other features, the method further comprises characterizing the road segment and the driver behavior based on a plurality of lane changes made by the vehicle and by other vehicles in the road segment.

In other features, the method further comprises informing drivers of the vehicle and other vehicles about the characterizations of the road segment and the driver behavior for navigation planning.

In other features, the method further comprises controlling the vehicle and other vehicles based on the characterizations of the road segment and the driver behavior.

In other features, the method further comprises determining a location of the vehicle in a lane based on the telemetry data and mapping data of the lane received from a lane-level mapping system, and detecting the lane changes based on the determined location of the vehicle.

In other features, the method further comprises dividing a road on which the vehicle is being driven into customized road segments, which include the road segment, receiving the telemetry data from the vehicle as the vehicle is being driven on the road, determining location information of the vehicle based on the telemetry data and mapping data of the road received from a road-level mapping system, caching the location information paired with the road segments. detecting the lane changes by processing the cached location information paired with the road segments, and characterizing the road segments and the driver behavior based on the lane changes and the telemetry data.

In other features, the method further comprises providing the characterization of the road segment to a traffic management system, providing the characterization of the driver behavior to a fleet management system associated with the vehicle, and providing the characterization of the driver behavior to an insurer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a block diagram of an example of a system for estimating lateral dynamics of vehicles using telemetry data of the vehicles;

FIG. 2 shows an example of lanes in a road segment;

FIG. 3 shows an example of a lane change event in a road segment;

FIG. 4 shows an example of lateral movement of a vehicle;

FIG. 5 shows an example of a method for detecting a lane change of a vehicle;

FIG. 6 shows an example of a method for characterizing a road segment and driver behavior based on lane changes;

FIG. 7 shows the method of FIG. 6 for characterizing a road segment and driver behavior based on lane changes in further detail;

FIG. 8 shows an example of a method for characterizing a road segment and driver behavior using lane level mapping data;

FIG. 9 shows an example of a method for characterizing a road segment and driver behavior using road level mapping data;

FIG. 10 shows an example of a method for scoring a road segment based on lane changes detected in the road segment; and

FIGS. 11 and 12 show examples of methods for scoring driver behavior based on lane changes and telemetry data.

In the drawings, reference numbers may be reused to identify similar and/or identical elements.

### DETAILED DESCRIPTION

Lateral dynamics of vehicles (e.g., how vehicles drive within a lane before, during, and after changing lanes) are part of road risk assessment. Analyzing lane behavior of vehicles is an important part of driver risk assessment. Driver behavior monitoring systems currently used in the vehicles (e.g., systems used as part of usage-based insurance) measure only instantaneous hard braking, hard acceleration, and speed exceeding a particular limit without any information about lateral dynamics of the vehicles. Some vehicles are equipped with lane departure warning systems that use onboard cameras installed in the vehicles to monitor whether the vehicles follow a lane or veer into another lane and to maintain headway (distance between vehicles). However, these camera-based systems are computationally intensive and yet do not provide any information about lateral dynamics of the vehicles.

The present disclosure provides systems and methods that use telemetry data and crowd-sensing technology to determine events associated with the vehicles' lane changes (called lane change events) and to characterize lateral driving behavior of drivers both individually and collectively. The lane change events may also be used as part of aggregate road risk assessment and to assess individual driver risk (e.g., for usage-based insurance). Accordingly, the assessments of individual driver risk and insurance, which are traditionally based on individual driving behavior alone, can instead be improved using the context of aggregate lateral dynamics of other vehicles.

The systems and methods can detect lane level and road level lane changes and can infer the lane change events from telemetry data of vehicles. The systems and methods can assess lateral driving behavior of individual drivers from the telemetry data and perform risk assessment to identify roadways (or segments thereof) with unsafe lateral dynamics (e.g., to plan future road projects). The systems and methods can perform vehicle adaptations (e.g., in autonomous and semi-autonomous vehicles) and infrastructure adaptations (e.g., route selection) based on metrics (called vulnerable road segment detection) derived from the telemetry data.

The systems and methods provide two types of lateral dynamics assessments. In individual assessments, the systems and methods use telemetry data from individual vehicles to identify the lane change events, characterize the lane change and lane following behavior of the drivers, and use the data to score the drivers. In aggregate assessments, using collective telemetry data from many vehicles, the systems and methods assess road risk and identify road segments that experience high levels of lateral dynamics (e.g., lane changes, anomalous lane following behavior, etc.). High levels of lateral dynamics indicate potential for unexpected events (e.g., cutting in) that may cause major instability in traffic flow. Vehicles can inform drivers in areas of unstable traffic flow and can make adaptations to increase safety (e.g., adapt following distance).

Specifically, telemetry data such as GPS data of a vehicle is collected from an on-board GPS receiver in the vehicle. The telemetry data includes additional data such as speed and heading of the vehicle sensed by other sensors in the vehicle. For example, speed and heading of the vehicle can be calculated from GPS data. The systems and methods significantly improve prior art by functioning with minimal telemetry data—specifically, GPS data only—and do not require a real-time data stream to function, due to which, only about 3-second location updates are sufficient to perform lane change detection and characterization. Other approaches may require lateral acceleration, yaw rate, steering wheel angle, camera systems, relatively high update rate, etc.). The telemetry data does not include data captured by any cameras in the vehicle. The telemetry data provides location information and the speed of the vehicle. The telemetry data is collected from the vehicle periodically (e.g., at an interval of a plurality of seconds or minutes). The lane change behavior can be determined based on this data as explained below in detail.

The lane change behavior detected based on the telemetry data periodically received from the vehicles can be useful in many applications. For example, the lane change behavior can be used to assess driver risk for insurance purposes. Aggregated lane change data can be used to estimate road safety risk. Since there is a correlation between the number of lane changes and accidents, a road segment can be characterized as being safe or unsafe based on the number of lane changes in the road segment.

For example, a road segment, or more specifically a particular lane or a set of lanes in the road segment, may be determined as being unsafe during particular times (e.g., rush hour, weather conditions, etc.) based on detected lane changes therein. Accordingly, roads can be divided into segments, and road segments can be characterized as safe or unsafe during times of the day, days of week, seasons, and so on. Thus, roads and road segments can be profiled, and that information can be dynamically added to the map or navigation applications to inform (e.g., alert) drivers about road risks in particular road segments.

The added information can also assist autonomous and semi-autonomous vehicles in selecting alternate routes and making other adaptations such as maintaining safe distance between vehicles. Further, existing roads can be redesigned/reconfigured to reduce the road risk in road segments having elevated number of lane changes, and future roads can be designed to minimize such risks. Thus, the systems and methods improve the navigation systems of vehicles, traffic management systems, fleet management systems, and insurance industry. These and other features of the present disclosure are described below in further detail.

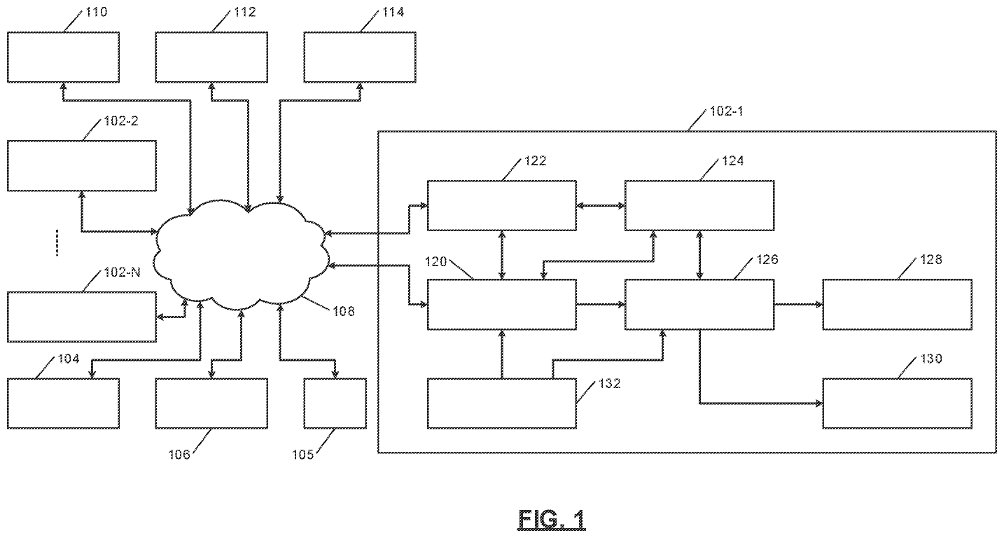

FIG. 1 shows a system 100 comprising a plurality of vehicles 102-1, 102-2, . . . , and 102-N (collectively the vehicles 102), where N is a positive integer; one or more servers 104 (e.g., located in a cloud); a global positioning system (GPS) 105; and one or more mapping systems 106 communicating with each other via a distributed communication system 108. The vehicles 102 and the servers 104 may communicate directly with the GPS 105.

The system 100 further comprises one or more traffic management systems (e.g., department of transportation) 110, one or more fleet management systems 112, and one or more insurance systems 114. These systems communicate with the vehicles 102 and the servers 104 via the distributed communication system 108. For example, the distributed communication system 108 may include a local area network (LAN), a wide area network (WAN), a cellular network, a WiFi network, and the Internet.

Hereinafter, the vehicle 102-1 will be called the vehicle 102, and the description provided for the vehicle 102 will apply equally to each of the vehicles 102. Further, the servers 104, the mapping systems 106, the traffic management systems 110, the fleet management systems 112, and the insurance systems 114 will be called the server 104, the mapping system 106, the traffic management system 110, the fleet management system 112, and the insurance system 114.

The vehicle 102 comprises a navigation subsystem 120, a communication subsystem 122, an infotainment subsystem 124, an autonomous subsystem 126, a steering subsystem 128, a braking subsystem 130, and a plurality of sensors 132. The navigation subsystem 120 communicates with the server 104, the GPS 105, and the mapping system 106 via the distributed communication system 108. The navigation subsystem 120 may communicate with the GPS 105 directly or via the communication subsystem 122.

The communication subsystem 122 communicates with the navigation subsystem 120 and may include one or more transceivers (e.g., a cellular transceiver, a WiFi transceiver, a GPS receiver, and a Bluetooth transceiver) suitable for communicating with the distributed communication system 108, the GPS 105, and a mobile device such as a cellular phone. The communication subsystem 122 may also communicate with the GPS 105 directly. Further, the communication subsystem 122 may also communicate with other vehicles using vehicle-to-vehicle (V2V) communication technology.

The navigation subsystem 120 communicates with the infotainment subsystem 124. The infotainment subsystem 124 may comprise a display screen (e.g., a touch screen) and multimedia devices (e.g., a speaker and a microphone) for audiovisual interactions with the driver and other occupants of the vehicle 102. The navigation subsystem 120 can provide maps and other audiovisual information to the driver and other occupants of the vehicle 102 via the infotainment subsystem 124. The navigation subsystem 120 can also receive audiovisual inputs from the driver and other occupants of the vehicle 102 via the infotainment subsystem 124.

The autonomous subsystem 126 controls the operations of the vehicle 102 by controlling the steering subsystem 128 and the braking subsystem 130 based on data received from the navigation subsystem, the infotainment subsystem 124, and the sensors 132. The navigation subsystem 120 and the autonomous subsystem 126 receive data from the sensors 132 and the GPS receiver in the communication subsystem 122. For example, the sensors 132 may include sensors that provide speed, heading, yaw rate, and turn indication of the vehicle 102. The data from the sensors 132 and the GPS receiver are collectively called the telemetry data of the vehicle 102.

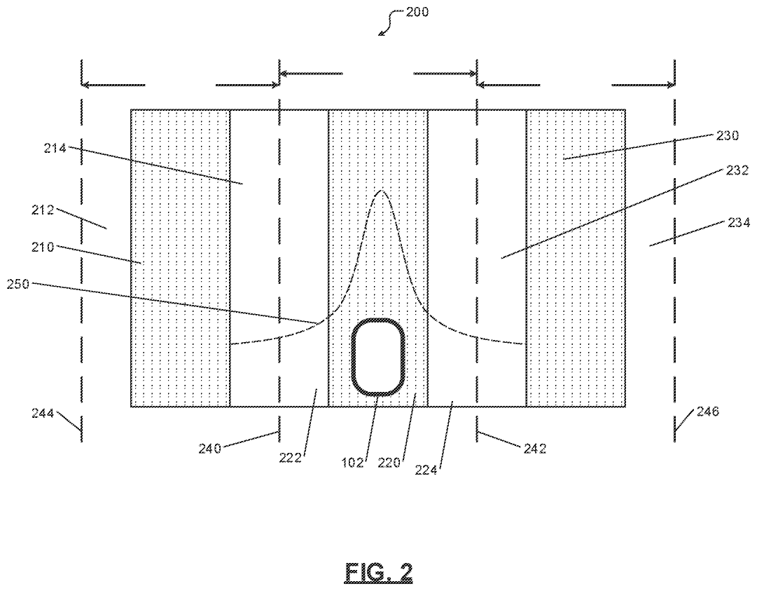

The operation of the system 100 is now explained below in detail with reference to the remaining figures. Before explaining the operation of the system 100, the lateral dynamics of the vehicle 102 are initially explained with reference to FIGS. 2-5.

FIG. 2 shows an example of a road segment 200 comprising 3 lanes: Lane A 202, Lane B 204, and Lane C 206. Each lane includes a core zone (i.e., a center zone) and two boundary zones, one each on either side of the center zone. For example, the Lane A 202 includes a center zone 210 and boundary zones 212, 214; the Lane B 204 includes a center zone 220 and boundary zones 222, 224; and the

Lane C 206 includes a center zone 230 and boundary zones 232, 234.

The lanes are separated by lane markers. For example, the Lane A 202 is separated from the Lane B 204 by a lane marker 240 located between the boundary zone 214 of the Lane A 202 and the boundary zone 222 of the Lane B 204. The Lane B 204 is separated from the Lane C 206 by a lane marker 242 located between the boundary zone 224 of the Lane B 204 and the boundary zone 232 of the Lane C 206. A lane marker 244 adjacent to the boundary zone 212 of the Lane A 202 marks the end of the Lane A 202. A lane marker 246 adjacent to the boundary zone 234 of the Lane C 206 marks the end of the Lane C 206.

Some vehicles drive predominantly in the center zone of a lane. However, some vehicles tend to drive closer to one or the other (left or right) boundary zone of the lane. Still other vehicles tend to oscillate between the two (left and right) boundary zones of the lane. A Gaussian probability density function (also called a model) 250 is formulated based on the movement of the vehicle 102 in a lane. The Gaussian probability density function 250 indicates a probability of the vehicle 102 being in the center zone of the lane or being in one or the other boundary zone of the lane. The Gaussian probability density function 250 is given by the equation:

$$p ( y ) = \frac{1}{σ \sqrt{2 π}} {e}^{- \frac{{( y - μ )}^{2}}{2 {σ}^{2}}}$$

where y denotes a lateral offset measurement for the vehicle 102 indicating how far off the vehicle 102 is from the center zone of a lane, a denotes a standard deviation, and μ denotes a mean value of the location of the vehicle 102 in the lane.

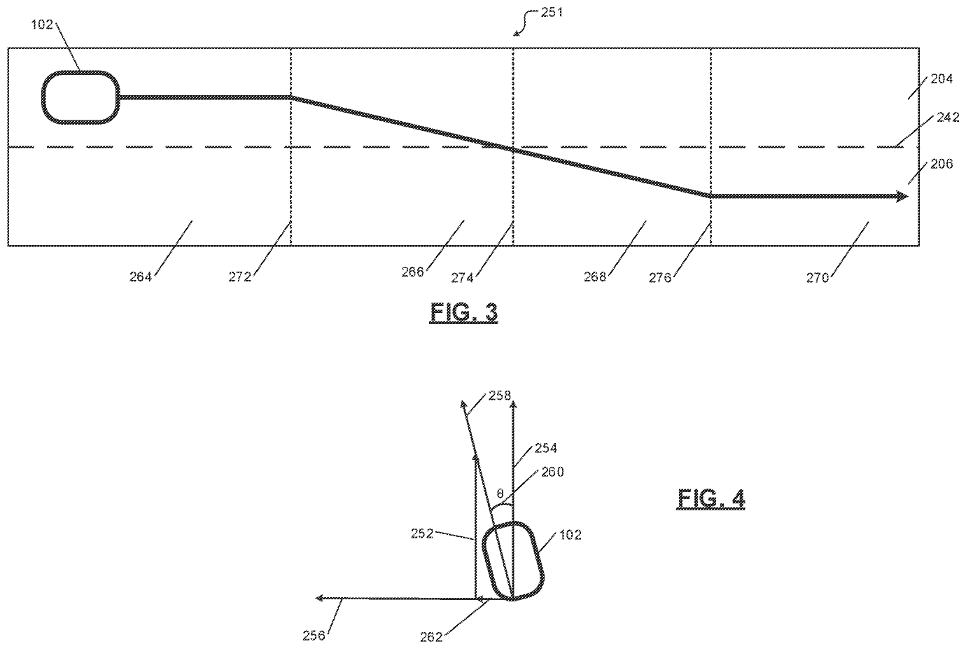

FIG. 3 shows an example of a lane change 251 performed by the vehicle 102. A lateral velocity of the vehicle 102 is useful in estimating lateral movement of the vehicle 102 during a lane change. FIG. 4 shows calculation of the lateral velocity. Suppose that the vehicle 102 is moving at a vehicle speed Vᵥ 252 along a road direction 254. A lateral direction 256 is perpendicular to the road direction 254. When changing lane, the vehicle 102 moves laterally in a vehicle direction 258 at an angle θ 260 relative to the road direction 254. The lateral velocity Vₗₐₜ 262 of the vehicle 102 is given by the equation Vₗₐₜ=Vᵥ*sin θ.

In FIG. 3, for example, the vehicle 102 may move from the Lane B 204 to the Lane C 206 as follows. Suppose that the vehicle 102 is initially moving along the road direction 254 in the center zone 220 of the Lane B 204 at the vehicle speed Vᵥ 252. Until 272, the lateral velocity Vₗₐₜ 262 of the vehicle 102 is nearly zero, and the vehicle 102 is said to be keeping or maintaining the Lane B 204 as shown at 264.

At 272, the lateral velocity Vₗₐₜ 262 of the vehicle 102 increases, and the vehicle 102 moves into the boundary zone 224 of the Lane B 204. Until 274, the vehicle 102 is said to be changing the Lane B 204 as shown at 266.

At 274, with the lateral velocity Vₗₐₜ 262 of the vehicle 102 increasing or remaining relatively constant, the vehicle 102 traverses the boundary zone 224 of the Lane B 204, crosses the lane marker 242, and moves into the boundary zone 232 of the Lane C 206. Until 276, the vehicle 102 is said to be arriving in the Lane B 204 as shown at 268.

At 276, the lateral velocity Vₗₐₜ 262 of the vehicle 102 decreases, and the vehicle 102 moves into the center zone 230 of the Lane C 206. Thereafter, the vehicle 102 adjusts or settles in the center zone 230 of the Lane C 206 as shown at 270, the lateral velocity Vₗₐₜ 262 of the vehicle 102 becomes nearly zero, and the lane change 251 is detected as being complete.

Sometimes, the vehicle 102 may reverse course anywhere between 272 and 276 and return to the Lane B 204, in which case, the vehicle 102 is said to have not made the lane change 251, and no lane change is detected. The detection of the lane change 251, which includes the calculation of the lateral velocity vₗₐₜ 262 of the vehicle 102 and additional consideration of other telemetry data of the vehicle 102 (e.g., the GPS location of the vehicle 102 and lane level or road level data from the mapping systems 106), is performed by the server 104 as follows.

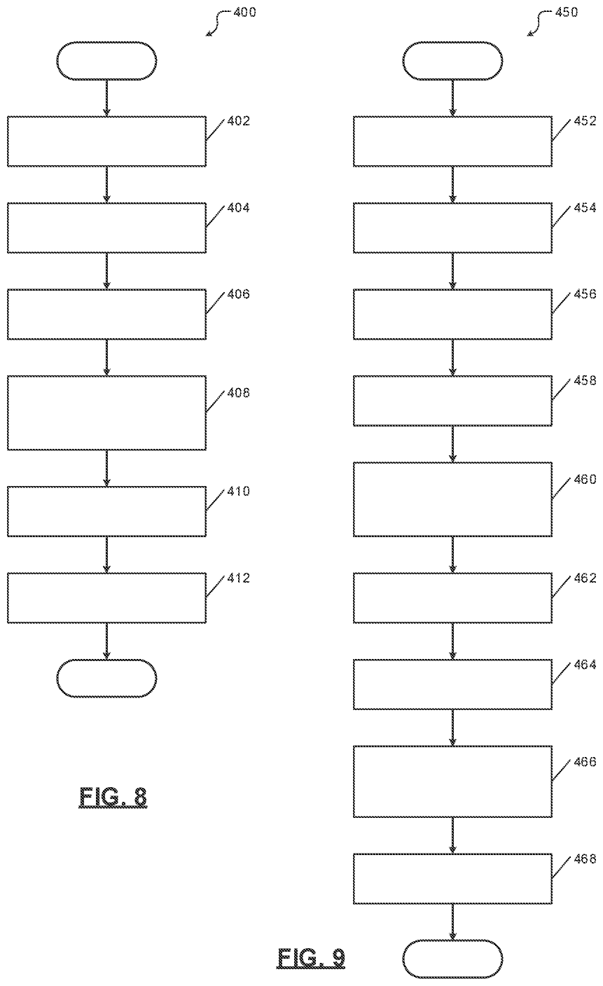

FIG. 5 shows an example of a method 300 performed by the server 104 to detect a lane change (e.g., the lane change 251) made by the vehicle 102. While the method 300 is described as being performed by the server 104, some of the processing steps may be performed by the navigation subsystem 120. At 302, the server 104 receives the telemetry data of the vehicle 102 (e.g., data from the sensors 132 and the GPS receiver in the communication subsystem 122) from the communication subsystem 122. At 304, the server 104 estimates the location of the vehicle 102 in a lane based on the telemetry data and mapping data (e.g., GPS coordinates of the center of the lane or the GPS data of the road) received from the mapping system 106 (explained in further detail with reference to FIGS. 8 and 9).

At 306, using the model 250, the server 104 determines a zone of the lane in which the vehicle 102 is located (e.g., whether the vehicle 102 is located in the center zone or one of the boundary zones of the lane). At 308, the server 104 calculates the lateral velocity of the vehicle 102 as described above.

At 310, based on the location and the lateral velocity of the vehicle 102 determined based on the model 250 and the telemetry data of the vehicle 102, the server 104 determines whether the vehicle 102 is keeping (i.e., maintaining) the lane. The method 300 returns to 302 if the server 104 determines that the vehicle 102 is keeping the lane.

If the server 104 determines that the vehicle 102 is not keeping the lane, at 312, the server 104 determines if the vehicle 102 is changing the lane. The method 300 returns to 302 if the server 104 determines that the vehicle 102 is not changing the lane.

If the server 104 determines that the vehicle 102 is changing the lane, at 314, the server 104 determines if the vehicle 102 has arrived in the new lane. The method 300 returns to 302 if the server 104 determines that the vehicle 102 has not arrived in the new lane. For example, the vehicle 102 may not arrive in the new lane if the vehicle 102 (or the driver of the vehicle 102) decides not to change the lane and returns to the original lane.

If the server 104 determines that the vehicle 102 has arrived in the new lane, at 316, the server 104 determines if the vehicle 102 has adjusted (i.e., settled) in the new lane. The method 300 returns to 302 if the server 104 determines that the vehicle 102 has not arrived in the new lane. For example, the vehicle 102 may not settle in the new lane if the vehicle 102 (or the driver of the vehicle 102) decides to terminate the lane change and returns to the original lane. If the server 104 determines that the vehicle 102 has settled in the new lane, at 318, the server 104 detects that the lane change is completed.

At 320, the server 104 determines an amount of time taken to complete the lane change. At 322, the server 104 determines if the amount of time taken to complete the lane change is less than or equal to a predetermined threshold. That is, the server 104 determines a speed at which the lane change is completed. At 324, the server 104 determines that the lane change is completed aggressively if the amount of time taken to complete the lane change is less than or equal to the predetermined threshold. At 326, the server 104 determines that the lane change is completed gradually if the amount of time taken to complete the lane change is greater than the predetermined threshold. This determination is used, along with similar determinations made based on lane changes made by other vehicles 102 in the road segment to characterize the road segment as having (or not having) an elevated level of lane changes and to characterize the driver's behavior as being risky (or safe) as described below in further detail.

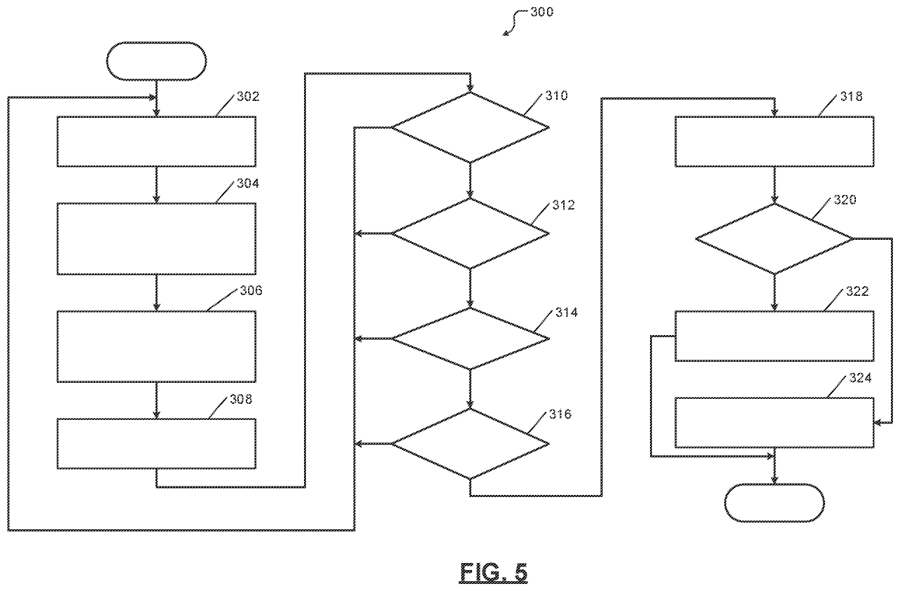

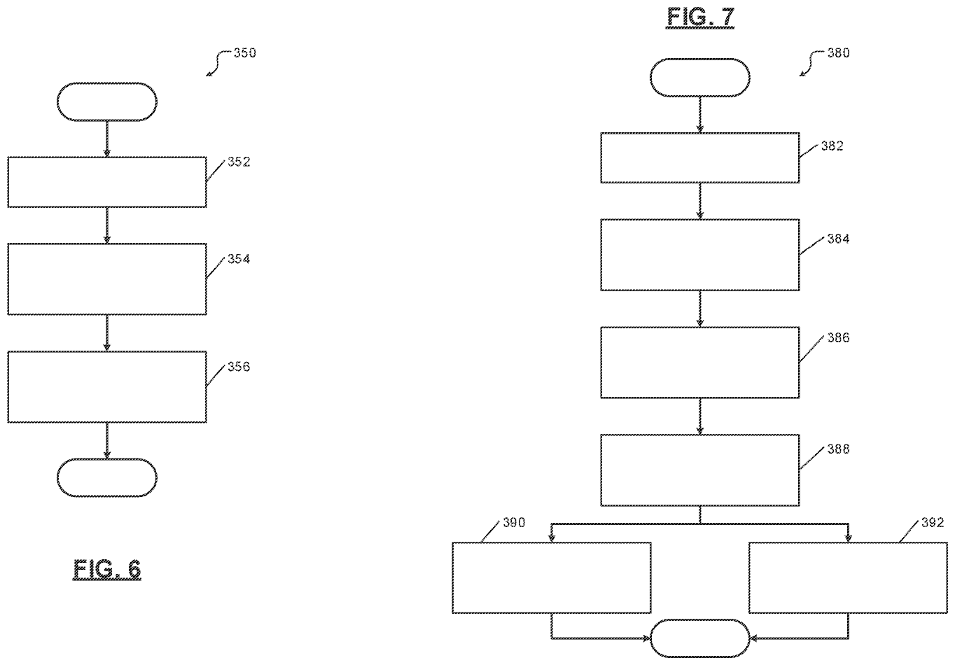

FIGS. 6 and 7 show methods for characterizing road segments and driver behaviors based on the telemetry data of the vehicles 102 and for using the characterizations to plan subsequent mitigating actions (e.g., informing/controlling drivers/vehicles, road designing, fleet management, etc.). FIGS. 8 and 9 respectively show the lane change detections performed based on lane level and road level mapping data in further detail. FIGS. 10-12 show examples of use cases where the characterizations and scoring of road segments and driver behaviors are used for road design, fleet management, and insurance purposes.

FIG. 6 shows a method 350 performed by the server 104 to characterize a road segment and driver behavior based on the telemetry data of a vehicle. FIG. 6 shows an overview of the characterizations. FIG. 7 shows the characterizations and subsequent actions in further detail.

In FIG. 6, at 352, the server 104 receives telemetry data from a vehicle 102 (filtered or unfiltered as explained below in detail with reference to FIGS. 8 and 9) being driven in the road segment. At 354, the server 104 detects the lane changes made by the vehicle 102 and detects driver behavior (e.g., lane changes, driving speed, headway, etc.) in the road segment based on the telemetry data received from the vehicle 102 as described above with reference to FIGS. 2-5. While only one road segment is used as an example for simplicity of illustration, the server 104 can detect lane changes and driver behavior in multiple road segments.

At 356, the server 104 characterizes the road segment based on the lane changes made by the vehicle 102 and characterizes driver behavior based on the lane changes, driving speed, headway, etc. of the vehicle 102. For example, the server 104 characterizes the road segment (or multiple road segments) as having instances of more than a predetermined number of total lane changes, more than a predetermined number of fast lane changes, and so on. The server 104 assigns a score to the road segment (or multiple road segments) based on the lane changes as described below in further detail with reference to FIG. 10. In some examples, the server 104 may further characterize a set of lanes of the road segment (or multiple road segments) in which most of the lane changes (or faster lane changes) are performed by the vehicle 102.

In addition, at 356, the server 104 also characterizes driver behavior including whether the vehicle 102 wavers within a lane (i.e., drives in boundary zones instead of the center zone of a lane), whether the driver drives the vehicle 102 in a zig-zag manner (i.e., moves into a boundary zone of an adjacent lane and moves back into the original lane), etc. in the road segment (or multiple road segments). As described below, these characterizations are helpful for other vehicles in planning travel (e.g., by making route selection and lane selection, managing headway and speed, etc.). These characterizations are also helpful for reconfiguring existing roads and designing new roads, fleet management, and assessing risks posed by the driver of the vehicle 102 for insurance purposes as explained below in further detail.

FIG. 7 shows a method 380 performed by the server 104 to characterize a road segment and driver behavior of a vehicle based on aggregate lane changes and aggregate driver behaviors of a plurality of vehicles in detail. The method 380 performs the characterizations collectively based on telemetry data of a plurality of vehicles instead of based on telemetry data of a single vehicle.

In FIG. 7, at 382, the server 104 receives telemetry data from the vehicles 102 (filtered or unfiltered as explained below in detail with reference to FIGS. 8 and 9) being driven in a road segment. At 384, the server 104 detects the lane changes made by the vehicles 102 and detects driver behaviors (e.g., lane changes, driving speed, headway, etc.) of the vehicles 102 in the road segment based on the telemetry data. Again, while only one road segment is used as an example for simplicity of illustration, the server 104 can detect lane changes and driver behaviors of the vehicles 102 in multiple road segments.

At 386, the server 104 characterizes and scores the road segment based on the aggregate lane changes made by the vehicles 102. For example, the server 104 characterizes the road segment (or multiple road segments) as having instances of more than a predetermined number of total lane changes, more than a predetermined number of fast lane changes, and so on. The server 104 assigns a score to the road segment (or multiple road segments) based on the lane changes as described below in further detail with reference to FIG. 10. In some examples, the server 104 may further characterize a set of lanes of the road segment (or multiple road segments) in which most of the lane changes (or faster lane changes) are performed by the vehicles 102.

At 388, the server 104 characterizes and scores aggregate driver behaviors based on the lane changes, driving speed, headway, etc. of the vehicles 102. Specifically, the server 104 characterizes driver behavior of one of the vehicles including whether the driver wavers within a lane (i.e., drives in boundary zones instead of the center zone of a lane), whether the driver drives in a zig-zag manner (e.g., moves into a boundary zone of an adjacent lane and moves back into the original lane), etc., by taking into account the aggregate driver behaviors of all the vehicles 102 in the road segment (or multiple road segments).

At 390, the server 104 informs drivers of other vehicles (e.g., via the infotainment subsystem 124 ) about the characterizations of the road segment(s) and driver behaviors of the vehicles 102 to plan navigation of their vehicles. For example, as described below, these characterizations can be helpful for other vehicles in planning travel (e.g., by making route selection and lane selection, managing headway and speed, etc.).

Alternatively or additionally, at 392, the server 104 can provide information about the characterizations of the road segments and driver behaviors directly to autonomous or semi-autonomous vehicles (e.g., to the navigation subsystem 120 and/or the autonomous subsystem 126 of these vehicles, in addition to or as an alternative to informing the drivers via the infotainment subsystem 124 of these vehicles) to plan and control navigation of these vehicles.

These characterizations can also be helpful for reconfiguring existing roads and designing new roads and for fleet management as explained below in detail. Further, these characterizations can be helpful for insurers for assessing risks posed by the driver of the vehicle 102 by taking into account the context provided by the aggregate driver behaviors of all the vehicles.

Accordingly, the server 104 can provide the characterizations of the road segment(s) and driver behaviors to the traffic management systems 110 to help with reconfiguring existing road segments and designing future roads to minimize or alleviate the risks posed by the lane changes. For example, to mitigate risks in road segments having elevated lane changes, the traffic management systems 110 can add a lane, make lane markings solid (i.e., continuous instead broken lines), add signs such as stay in lane to indicate that no lane change is permitted, and so on.

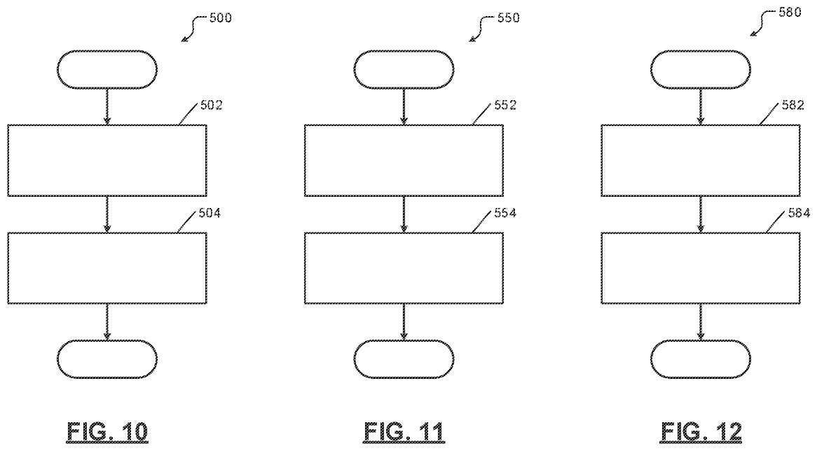

Further, the server 104 also scores the drivers' behaviors based on the telemetry data of their vehicles and their lane changes, both individually as well as in the context of the behaviors of other drivers, as described in further detail with reference to FIGS. 11 and 12. The server 104 provides the driver scores to the fleet management systems 112 to help with driver training to improve their behaviors. The server 104 provides the driver scores to the insurance systems 114 to help with risk assessments of individual drivers in the context of aggregate driver behaviors of multiple vehicles.

FIG. 8 shows a method 400 for detecting lane changes based on lane level mapping data. The lane level mapping data is high-definition mapping data (e.g., GPS coordinates) of lanes of road segments and is provided by the mapping system 106. At 402, the server 104 receives telemetry data from the vehicle 102 being driven in a road segment. At 404, the server 104 filters the telemetry data (e.g., omits data related to stops made by the vehicle 102 for gas, food, parking, etc., which is unnecessary for detecting lane changes).

At 406, the server 104 receives lane level mapping data from the mapping system 106. The mapping data serves as reference for determining location of the vehicle 102 based on the telemetry data received from the vehicle 102. At 408, the server 104 estimates the location of the vehicle 102 based on the filtered telemetry data and the mapping data. The server 104 determines the zone of the lane in which the vehicle 102 is located using the model 250.

At 410, the server 104 calculates the lateral velocity of the vehicle 102 based on the telemetry data received from the vehicle 102. At 412, the server 104 detects whether the vehicle 102 changed the lane based on the location of the vehicle 102 and the lateral velocity of the vehicle 102 by using the method 300 shown and described with reference to FIGS. 2-5.

FIG. 9 shows a method 450 for detecting lane changes based on road level mapping data provided by the mapping system 106. At 452, the server 104 receives telemetry data from the vehicle 102 being driven in a road segment. For example, the telemetry data includes the GPS data of the vehicle 102 along with a time stamp, a trip ID for the travel of the vehicle 102, heading of the vehicle 102, etc. At 454, the server 104 filters the telemetry data (e.g., omits data related to stops made by the vehicle 102 for gas, food, parking, etc., which is unnecessary for detecting lane changes).

At 456, the server 104 receives road level mapping data from the mapping system 106. Unlike the lane level mapping data, the road level mapping data is not high-definition mapping data of lanes of road segments. Rather, the road level mapping data is low resolution mapping data of road networks provided by a map matching service such as open source routing machine (OSRM) based on geographic data provided by open street map (OSM) system. The road level mapping data serves as reference for determining location of the vehicle 102 based on the telemetry data received from the vehicle 102.

At 458, the server 104 divides the roads into customized segments. For example, the server 104 divides the roads uniformly into segments of equal lengths rather than based on road geometry. The server 104 assigns a segment ID to each road segment.

At 460, the server 104 estimates the location of the vehicle 102 based on the telemetry data and the mapping data. At 462, the server 104 stores (e.g., caches) the location data of the vehicle 102 paired with the road segments. The location data of the vehicle 102 is chronologically (i.e., in time sequence) aligned with the road segments using the time stamps in the telemetry data and the road segment IDs. At 464, the server 104 processes the cached time-aligned location data and detects lane changes and driver behavior of the vehicle 102 in the road segments.

At 466, the server 104 characterizes the road segments and driver behavior based on the lane changes. These characterizations are already described above in detail, and their description is therefore not repeated for brevity.

At 468, the server 104 aggregates the characterized lane changes and driver behaviors of a plurality of vehicles. The server 104 normalizes the lane changes and driver behaviors with the geographical data of the roads from the OSM database (e.g., the number of lanes in the road segments, the type of road such as highway or divided highway, speed limit, etc.). The server 104 stores the normalized data in a database for scoring and reporting (e.g., to drivers, vehicles, and third parties such as the traffic management system 110, the fleet management system 112, and the insurance system 114 ) as described above. Again, the description is not repeated for brevity.

FIG. 10 shows a method 500 for scoring road segments. At 502, for example, the server 104 calculates the scores for the road segments using the following equation (other alternate methods can be used instead).

vᵢ=α₁·L+α₂·W+α₃·S+α₄·R+α₅·Len+α₆·AC+α₇·GC+α₈·NC+α₉·N

where, for each road segment Sᵢ, L denotes a number of lanes in the road segment, W denotes a lane width, S denotes a speed limit in the road segment, R denotes a type of road (e.g., highway, divided highway, surface street, etc.), Len denotes a length of the road segment, AC denotes a number of aggressive lane changes (performed faster than a predetermined time) in the road segment, GC denotes a number of gradual lane changes (performed in greater than the predetermined time) in the road segment, NC denotes a number of normal lane changes (e.g., performed using a turn signal and less aggressively and less gradually) in the road segment, N denotes a total number of samples (e.g., the amount of lane change data) used in the road segment, and α₁ through α₉ are constants.

At 504, the server 104 provides the scores of the road segments to an agency that designs/plans roads. For example, the agency may be the department of transportation, which is generally shown as the traffic management systems 110 in FIG. 1. The agency may reconfigure existing roads and design future roads based on the scores.

FIG. 11 shows a method 550 for scoring driver behavior of a driver. At 552, the server 104 calculates various scores or metrics for a driver's behavior as follows. These metrics indicate various aspects of driver behavior including lane changes.

For example, the server 104 calculates a trip length value TLᵢ using the following equation:

TL=TCₜₒₜₐₗ−TCₛₜₒₚ

where TCₜₒₜₐₗ denotes a total time count for a trip, and TCₛₜₒₚ denotes a total time count for when the vehicle 102 is stopped (e.g., at a traffic light, and for gas, food, or parking, etc.). The trip length value TLᵢ is the total length of the trip in time domain. This metric in combination with the other metrics described below can indicate whether a driver drives more aggressively in trips of particular distances (e.g., short trips) but drives normally in other trips (e.g., long trips).

The server 104 calculates the following trip lateral metric along with minimum and maximum values of a vehicle's lateral movement during a trip:

IQR=(N+1)¾−(N+1)¼

where IQR denotes an interquartile range of the lateral offset measurement of the vehicle 102, and N denotes a total number of data points. IQR is also called mid-spread of middle 50% and is a measure of statistical dispersion, being equal to the difference between 75^{th} and 25^{th} percentiles, or between upper and lower quartiles. IQR indicates driver behavior in a segment.

The server 104 calculates a lateral dynamics value LDᵢ using the following equation:

$$σ = \sqrt{\frac{\sum {( {x}_{i} - μ )}^{2}}{N}}$$

where μ denotes mean value, σ denotes standard deviation, x denotes the lateral offset measurement, and xᵢ denotes the number i of x. The lateral dynamics value LDᵢ measures the lateral dynamics intensity of the lateral offset measurement and indicates whether the driver changes lanes frequently.

The server 104 also calculates a coefficient of variation CV using the following equation (the variables are explained above):

$$cv = \frac{σ}{μ}$$

The coefficient of variation is another measurement of the lateral dynamics intensity calculated by normalizing the lateral dynamics value LDᵢ with a mean offset value.

The server 104 calculates various lateral dynamics behavior values using the following equations (some of the variables are explained above, additional variables are explained below).

For example, the server 104 calculates a lane preference LP using the following equation:

$$μ = \frac{\sum {x}_{i}}{N}$$

The lane preference LP is an averaged lateral offset measurement, which indicates the driver's lane preference (e.g., negative for the leftmost lane, positive for the rightmost lane). This metric is useful because the lane preference of a driver (e.g., left lane) can indicate aggressive behavior of the driver or can cause other drivers to drive aggressively (e.g., drive around a slow driver in the left lane and cutting in). Such analyses are possible due to the aggregation of telemetry data from multiple vehicles as explained above.

The server 104 also calculates a median value for lane preference LP using the following equation:

$$Med = \{ \begin{matrix}\frac{{x}_{[ \frac{N + 1}{2} ]} + {x}_{[ \frac{N}{2} ]}}{2} \\ {x}_{[ \frac{N + 1}{2} ]}\end{matrix}$$

The server 104 calculates an aggressive lane change frequency (agg), a gradual lane change frequency (gral), and a signaled lane change ratio (sigl) using the following equations:

$$agg = \frac{{CT}_{agg}}{{CT}_{total}} \\ gral = \frac{{CT}_{gral}}{{CT}_{total}} \\ sigl = \frac{{CT}_{on}}{{CT}_{total}}$$

where CT_{agg} denotes the number of aggressive lane changes, CT_{gral} denotes the number of gradual lane changes, CTₜₒₜₐₗ denotes the total number of lane changes, and CTₒₙ denotes the number of lane changes made using turn signals. These metrics provide further details about the lane changes, which in turn indicate driver behavior in greater detail.

At 554, the server 104 provides the driver scores to the fleet management system 112. The fleet management system 112 can take mitigating measures such as training drivers to improve their behavior.

FIG. 12 shows a method 580 for providing the driver scores to insurance companies. At 582, the server 104 calculates the scores for a driver as described above with reference to FIG. 11. At 584, the server 104 provides the driver scores to an insurance company, which is generally shown as the insurance systems 114 in FIG. 1. Since these scores include the context of driver behaviors of multiple drivers in which the scores for each driver are determined, the insurance company can perform a better risk assessment of a driver based on these scores than when the score of the driver is based on the driving behavior of the driver alone.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between subsystems, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “subsystem” may be replaced with the term “circuit.” The term “subsystem” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components such as sensors and actuators that provide the described functionality; or a combination of some or all of the above, such as in a system-on-chip.

The subsystem may include one or more interface circuits. In some examples, the interface circuits may include wired or wireless interfaces that are connected to a local area network (LAN), the Internet, a wide area network (WAN), or combinations thereof. The functionality of any given subsystem of the present disclosure may be distributed among multiple subsystem that are connected via interface circuits. For example, multiple subsystem may allow load balancing. In a further example, a server (also known as remote, or cloud) subsystem may accomplish some functionality on behalf of a client subsystem.

The term code, as used above, may include software, firmware, and/or microcode, and may refer to programs, routines, functions, classes, data structures, and/or objects. The term shared processor circuit encompasses a single processor circuit that executes some or all code from multiple subsystems. The term group processor circuit encompasses a processor circuit that, in combination with additional processor circuits, executes some or all code from one or more subsystems. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple subsystems. The term group memory circuit encompasses a memory circuit that, in combination with additional memories, stores some or all code from one or more subsystems.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
a processor; and
a memory storing instructions which when executed by the processor configure the processor to:
receive telemetry data from a vehicle being driven in a road segment;
detect lane changes made by the vehicle in the road segment based on the telemetry data; and
characterize the road segment and driver behavior based on the lane changes and the telemetry data.

2. The system of claim 1 wherein the instructions further configure the processor to:
estimate a location of the vehicle in a lane using the telemetry data and a model;
estimate a lateral velocity of the vehicle; and
detect the lane changes based on the location and the lateral velocity.

3. The system of claim 2 wherein the instructions further configure the processor to detect a lane change when the vehicle moves from a center of the lane to a boundary of the lane, from the boundary of the lane to a boundary of an adjacent lane, from the boundary of the adjacent lane to a center of the adjacent lane.

4. The system of claim 2 wherein the instructions further configure the processor to:
determine a time taken by the vehicle to make each of the lane changes; and
characterize the road segment and the driver behavior based on the time taken by the vehicle to make each of the lane changes.

5. The system of claim 1 wherein the instructions further configure the processor to characterize the road segment and the driver behavior based on a plurality of lane changes made by the vehicle and by other vehicles in the road segment.

6. The system of claim 5 wherein the instructions further configure the processor to inform drivers of the vehicle and other vehicles about the characterizations of the road segment and the driver behavior for navigation planning.

7. The system of claim 5 wherein the instructions further configure the processor to control the vehicle and other vehicles based on the characterizations of the road segment and the driver behavior.

8. The system of claim 1 wherein the instructions further configure the processor to:
determine a location of the vehicle in a lane based on the telemetry data and mapping data of the lane received from a lane-level mapping system; and
detect the lane changes based on the determined location of the vehicle.

9. The system of claim 1 wherein the instructions further configure the processor to:
divide a road on which the vehicle is being driven into customized road segments, which include the road segment;
receive the telemetry data from the vehicle as the vehicle is being driven on the road;
determine location information of the vehicle based on the telemetry data and mapping data of the road received from a road-level mapping system;
cache the location information paired with the road segments;
detect the lane changes by processing the cached location information paired with the road segments; and
characterize the road segments and the driver behavior based on the lane changes and the telemetry data.

10. The system of claim 5 wherein the instructions further configure the processor to provide the characterization of the road segment to a traffic management system, provide the characterization of the driver behavior to a fleet management system associated with the vehicle, and provide the characterization of the driver behavior to an insurer.

11. A method comprising:
receiving telemetry data from a vehicle being driven in a road segment;
detecting lane changes made by the vehicle in the road segment based on the telemetry data; and
characterizing the road segment and driver behavior based on the lane changes and the telemetry data.

12. The method of claim 11 further comprising:
estimating a location of the vehicle in a lane using the telemetry data and a model;
estimating a lateral velocity of the vehicle; and
detecting the lane changes based on the location and the lateral velocity.

13. The method of claim 12 further comprising detecting a lane change when the vehicle moves from a center of the lane to a boundary of the lane, from the boundary of the lane to a boundary of an adjacent lane, from the boundary of the adjacent lane to a center of the adjacent lane.

14. The method of claim 12 further comprising:
determining a time taken by the vehicle to make each of the lane changes; and
characterizing the road segment and the driver behavior based on the time taken by the vehicle to make each of the lane changes.

15. The method of claim 11 further comprising characterizing the road segment and the driver behavior based on a plurality of lane changes made by the vehicle and by other vehicles in the road segment.

16. The method of claim 15 further comprising informing drivers of the vehicle and other vehicles about the characterizations of the road segment and the driver behavior for navigation planning.

17. The method of claim 15 further comprising controlling the vehicle and other vehicles based on the characterizations of the road segment and the driver behavior.

18. The method of claim 11 further comprising:
determining a location of the vehicle in a lane based on the telemetry data and mapping data of the lane received from a lane-level mapping system; and
detecting the lane changes based on the determined location of the vehicle.

19. The method of claim 11 further comprising:
dividing a road on which the vehicle is being driven into customized road segments, which include the road segment;
receiving the telemetry data from the vehicle as the vehicle is being driven on the road;
determining location information of the vehicle based on the telemetry data and mapping data of the road received from a road-level mapping system;
caching the location information paired with the road segments;
detecting the lane changes by processing the cached location information paired with the road segments; and
characterizing the road segments and the driver behavior based on the lane changes and the telemetry data.

20. The method of claim 15 further comprising:
providing the characterization of the road segment to a traffic management system;
providing the characterization of the driver behavior to a fleet management system associated with the vehicle; and
providing the characterization of the driver behavior to an insurer.
